(19) United States
(12) Patent Application Publication
(10) Pub. No.: US 2026/0307575 A1
(43) Pub. Date: Oct. 8, 2026

(54) DEVICE, SYSTEM, AND/OR METHOD FOR SECURING A MOTORCYCLE

(71) Applicant: GLEN SEVERSON, Central Point, OR (US)

(72) Inventor: GLEN SEVERSON, Central Point, OR (US)

(21) Appl. No.: 19/482,858

(22) PCT Filed: May 10, 2024
(86) PCT No.: PCT/US2024/028775

§ 371 Date: Nov. 10, 2025

Related U.S. Application Data
(60) Provisional application No. 63/465,311, filed on May 10, 2023.
(60) Provisional application No. 63/565,963, filed on Mar. 15, 2024.

(51) Int. Cl. B60P 3/073

(52) U.S. Cl. CPC B60P 3/073

(57) ABSTRACT

Disclosed is a method, a device, apparatus, and/or a system for securing a motorcycle. In one embodiment, a rack for storing and/or transporting a motorcycle may include a first peg housing for receiving a first peg of the motorcycle and a second peg housing coupled to the first peg housing at a fixed distance for receiving pegs of the motorcycle. The rack may furthermore include a brace coupled to either peg housing for applying an upward force on the motorcycle, and where the first peg housing and the second peg housing configured to resist the upward force with a downward reaction force to secure the motorcycle while minimizing depression of a suspension. The rack may include a peg retainer mechanically coupled to the first peg housing configured to apply a forward force to the peg, where the peg housing is configured to resist with a backward reaction force.

### CROSS-REFERENCE TO RELATED APPLICATIONS

This application is a national stage entry of International Application No. PCT/US24/28775, filed May 10, 2024, entitled: DEVICE, SYSTEM, AND/OR METHOD FOR SECURING A MOTORCYCLE, which claims the benefit of U.S. Provisional Application No. 63/465,311, filed May 10, 2023, entitled: MOTORCYCLE, DIRTBIKE, BICYCLE, AND/OR OTHER LINEAR VEHICLE MOUNTING DEVICE, SYSTEM, AND/OR METHOD and U.S. Provisional Application No. 63/565,963, filed Mar. 15, 2024, entitled: MOTORCYCLE, DIRTBIKE, BICYCLE, AND/OR OTHER LINEAR VEHICLE MOUNTING DEVICE, SYSTEM, AND/OR METHOD. The patent applications identified above are incorporated here by reference in its entirety to provide continuity of disclosure.

### FIELD OF TECHNOLOGY

This disclosure relates generally to transportation, storage, and/or security of motorcycles.

### BACKGROUND

It may be known in the art that a motorcycle may be difficult to store, transport and/or lock in a secure upright position. For example, a user may attempt to strap the motorcycle down with straps, ties, and/or chains from various angles to stabilize the vehicle in an upright position. the user may then have to employ a locking mechanism.

The result may be potentially time consuming, relatively difficult to learn, and/or result in inconsistent levels of security. This method and/or other methods may also involve applying downward force on the top of the motorcycle, which may depress the suspension of the motorcycle. A depressed suspension of the motorcycle, especially during travel in or connected to another vehicle such as a car, truck, or trailer, may inherently involve vibration, bumps, and/or jolts.

A depressed suspension may also occur during storage over long periods of time. For the suspension, this may decrease lifespan, decrease performance, and/or increase maintenance. Similarly, it can be difficult to lock a motorcycle, and may require separate mechanisms in addition to those used to secure it in an upright and/or fixed position.

One device for addressing suspension depression is a fork brace, or fork guard, which can be retrofitted between the motorcycle frame and a tire to prevent engagement of the suspension when straps are used. However, such braces can break, and sometimes may time consuming and difficult install, especially if intended for use with straps.

Another device which can hold a motorcycle without straps is the Lock-N-Load offered by Risk Racing (https://riskracing.com/, accessed May 2024), which pull down on pegs of a motorcycle. However, this device also depresses the suspension of the motorcycle. Other devices may apply downward pressure on the motorcycle generally, for example from the seat or handlebars. Such product may lack security during both transport and storage because a substantial bump, jolt, or intentional downward pressure (e.g., applied by a thief) may remove the motorcycle from the rack.

New and improved systems, devices, and methods are needed for fast, efficient, secure, and protective storage and transport of motorcycles.

### SUMMARY

In one embodiment, a device may include a horizontal member. The device may also include a first vertical member coupled to the horizontal member. The device may furthermore include a peg housing at least one of coupled to and integrated into the first vertical member, where the peg housing having an opening of the peg housing configured to receive a peg of the motorcycle and a ceiling configured to counteract an upward force of the peg with a downward reaction force. The device may in addition include a first brace attachment point coupled to at least one of the horizontal member and the first vertical member, the first brace attachment point configured to receive a brace usable to generate an upward force on the motorcycle, where a suspension of the motorcycle remains fully relaxed when the upward force from the brace is applied and counteracted by the downward reaction force of the peg housing to protect and improve longevity of the suspension of the motorcycle.

Implementations may include one or more of the following features. The device may include: a second vertical member coupled to the horizontal member and running parallel to the first vertical member such that a channel is formed between the first vertical member and the second vertical member for receiving the motorcycle, and where the peg housing may include a forward wall for at least one of holding the peg of the motorcycle in the peg housing prior to application of the upward force and further assisting in retaining the peg of the motorcycle in the peg housing. The device where the brace attachment point adjustably coupled to at least one of the first vertical member and the horizontal member, the device may include: a brace engagement arm mechanically coupled to the brace attachment point that when the brace engagement arm is engaged engages the brace attachment point to apply an upward force to the brace. The device where at least one of the peg housing and the first vertical member configured to vertically adjust relative to the horizontal member to accommodate a height of the peg of the motorcycle. The device where the first brace attachment point is mechanically coupled to the vertical member, and a second brace attachment point is coupled to the second vertical member, where the first brace attachment point having a first brace shelf for receiving a first end of a crossmember of the brace and the second brace attachment point having a second brace shelf for receiving a second end of the crossmember of the brace, where the brace engagement arm mechanically coupled to the brace attachment point through a set of one or more hinges having a second hinge, and where engagement of the brace engagement arm rotates the first brace attachment point upward rotatably around the second hinge to apply the upward force to the brace. The device may include: a brace assembly mechanically coupled to the first vertical member having the brace attachment point, the one or more hinges, and the brace engagement arm, where the brace assembly mechanically coupled to the first vertical member to adjust a vertical position along the first vertical member to accommodate a height of a force point of the motorcycle, where at least one of the horizontal member, a coupling between the horizontal member and the first vertical member, and a coupling between the horizontal member and the second vertical member configured to adjust a distance between the first vertical member and the second vertical member to accommodate a width of the motorcycle, a platform coupled to and running perpendicular to the horizontal member, the platform extending between the first vertical member and the second vertical member for receiving wheels of the motorcycle, a hitch mount coupled to at least one of the horizontal member, the first vertical member, and the second vertical member for mounting the device to a hitch receiver of a motorized vehicle, a ramp coupled to the platform for enabling the motorcycle to be wheeled onto the platform when the platform is elevated from a ground level, a friction pad coupled to the ceiling for increasing a coefficient of friction with the peg when receiving the upward force from the peg and imparting the downward reaction force to the peg, where the peg retainer having a first lock point having a through hole through which at least one of a lock and a cotter pin can be positioned to lock the peg retainer in the engaged position for improved security of the motorcycle during at least one of storage and transport, and where the motorcycle is at least one of a sport bike and a dirt bike. The device may include: a peg retainer mechanically coupled to at least one of the horizontal member and the first vertical member having a peg retention pad engageable to at least one of cover an opening of the peg housing through which the peg is received and apply a forward force on the peg to counteract the forward force with a backward reaction force, to assist in retaining the peg of the motorcycle in the peg housing and dis-engageable to uncover the opening for removal of the peg from the peg housing. The device where the peg retainer may include: a first hinge rotatably hinging about a first hinge point coupled with the first vertical member to rotate the peg retention pad until at least one of blocking the opening and applying the forward force.

In one general aspect, apparatus may include a member extending a first length. The apparatus may also include a peg housing at least one of coupled to the member and integrated into the member having an enclosure having a first opening on one side configured to receive a peg of the motorcycle from a direction of travel of the motorcycle and a second opening facing the motorcycle through which the peg protrudes when the peg is housed in the enclosure, where the encloser having a ceiling and a forward wall. The apparatus may furthermore include a peg retainer mechanically coupled to the member having a peg retention pad engageable to cover the first opening of the peg to apply a forward force on the peg counteracted by a backward reaction force from the forward wall, to assist in retaining the peg of the motorcycle in the peg retainer, where the motorcycle is at least one of a sport bike and a dirt bike.

Implementations may include one or more of the following features. The apparatus may include: a peg retention assembly coupled to the member, having: the peg retainer, a first hinge rotatably hinging about a first hinge point coupled with the member to engage the peg retention pad over the first opening, and a retainer engagement arm mechanically coupled to the peg retainer such that engagement of the retainer engagement arm rotates the peg retainer around the first hinge point to engage the peg retention pad until applying the forward force. The apparatus where the peg retention assembly may include: one or more linkage arms mechanically coupling the retainer engagement arm with the peg retainer configured to cam over such that at least one of the backward reaction force and a different backward force further engages the retainer engagement arm, and a first lock point having a through hole extending through, when the peg retainer is engaged, at least two of the member, the peg retainer, one of the one or more linkage arms, and the retainer engagement arm, for receiving at least one of a lock and a cotter pin to lock the peg retainer in the engaged position during at least one of storage of the motorcycle and transport of the motorcycle. The apparatus may include: a brace assembly coupled to the member configured to apply an upward force on a force point of the motorcycle, where the ceiling configured to counteract with a downward reaction force an upward force applied to the peg resulting from the upward force on the force point, and where a suspension of the motorcycle remains fully relaxed when the upward force from the brace is applied and counteracted by the downward reaction force of the peg housing to protect and improve longevity of the suspension. The apparatus may include: a friction pad coupled to the ceiling for increasing a coefficient of friction with the peg when receiving the upward force from the peg and imparting the downward reaction force. The apparatus where the brace assembly may include: a brace shelf plate having brace shelf for receiving a first end of a crossmember, a second hinge rotatably hinging about a second hinge point coupled with the member to engage the brace shelf plate, a brace engagement arm mechanically coupled to the brace shelf plate that when engaged rotates the brace shelf plate upward around the second hinge point to apply the upward force, and one or more linkage arms mechanically coupling the brace shelf plate to the brace engagement arm configured to cam over such that at least one of the downward reaction force and a different downward force further engages the brace engagement arm. The apparatus may include: an adjustment track having at least two adjustment positions for adjusting a position of the brace assembly along the member for accommodating a height of the force point of the motorcycle, where the brace assembly may include a second lock point having a through hole extending through at least two of the member, the brace shelf plate, one of the one or more linkage arms, and the brace engagement arm, when the brace is engaged, for receiving at least one of a different lock and a different cotter pin to lock the brace in the engaged position during at least one of storage of the motorcycle and transport of the motorcycle, and where the motorcycle is at least one of a sport bike and a dirt bike.

In one general aspect, a rack may include a first peg housing for receiving a first peg of the motorcycle having a first encloser. The rack may also include a second peg housing coupled to the first peg housing at a fixed distance for receiving a second peg of the motorcycle having a second enclosure. The rack may furthermore include a brace coupled to the first peg housing and the second peg housing for applying an upward force on the motorcycle, and where the first peg housing and the second peg housing configured to resist the upward force with a downward reaction force to secure the motorcycle in the rack while minimizing depression of a suspension of the motorcycle.

Implementations may include one or more of the following features. The rack may include: a platform coupled to and extending between at least one of the first peg housing and the second peg housing for receiving wheels of the motorcycle, and a hitch mount coupled to at least one of the first peg housing and the second peg housing for mounting the rack to a hitch receiver of a motorized vehicle. The rack may include: a peg retainer mechanically coupled to the first peg housing configured to at least one of block the first peg housing such that the peg is trapped in the first peg housing and apply a forward force to the peg. The rack where the first peg housing and the second peg housing configured to adjust vertically relative to the platform to accommodate a height of the motorcycle, where the first peg housing and the second peg housing configured to adjust horizontally to change the fixed distance to accommodate a width of the motorcycle, and where the brace configured to adjust vertically to accommodate a height of a force point of the motorcycle for receiving the upward force of the brace. The rack may include: a first lock that locks the peg retainer in an engaged position to assist in securing the motorcycle, and a second lock that locks the brace in an engaged position to assist in securing the motorcycle.

### BRIEF DESCRIPTION OF THE DRAWINGS

The embodiments of this disclosure are illustrated by way of example and not limitation in the figures of the accompanying drawings, in which like references indicate similar elements and in which:

FIG. 1A illustrates a linear vehicle mount, which may be used alone or in combination with the embodiment of FIG. 1B, in which a linear vehicle such as a motorcycle (e.g., a sport bike, a dirt bike), bicycle, or snow bike, and/or other linearly balanced vehicle may be securely mounted for storage, repair, and/or transport, utilizing an upward force and a downward force to hold the linear vehicle, including without substantial depression of a suspension of the linear vehicle, according to one or more embodiments.

FIG. 1B illustrates another linear vehicle mount, which may be used alone or in combination with the embodiment of FIG. 1A, in which a linear vehicle such as a motorcycle may be securely mounted for storage, repair, and/or transport, utilizing a forward force and a backward force to hold the linear vehicle, including without substantial depression of a suspension of the linear vehicle, according to one or more embodiments.

FIG. 2A illustrates an example of linear vehicle that can be mounted on the linear vehicle mount of FIG. 1, specifically a dirt bike or motocross bike shown from a side view, including a set of two or more possible force points which can be utilized to secure the linear vehicle, according to one or more embodiments.

FIG. 2B further illustrates the example of FIG. 2A from a front view, according to one or more embodiments.

FIG. 3A through FIG. 10 illustrate a specific example of the linear vehicle mount adapted for a motorcycle.

FIG. 3A illustrates a vertical brace, according to one or more embodiments.

FIG. 3B illustrates another instance of the vertical brace, according to one or more embodiments.

FIG. 4 illustrates a base that can be coupled to two instances of the vertical brace of FIG. 3, according to one or more embodiments.

FIG. 5 illustrates two instances of the vertical brace of FIG. 3 installed on the base of FIG. 4, according to one or more embodiments.

FIG. 6A illustrates a frame brace assembly in a front view, according to one or more embodiments.

FIG. 6B illustrates another instance of the frame brace assembly in a side view, according to one or more embodiments.

FIG. 7 illustrates a frame brace installation view in which the frame brace of FIG. 6 is installed on the vertical braces of FIG. 3, according to one or more embodiments.

FIG. 8 illustrates a platform which is attachable to the base of FIG. 4 on which the linear vehicle can rest, according to one or more embodiments.

FIG. 9 illustrates a folding ramp that can be used to guide the linear vehicle onto the platform of FIG. 8 when the platform is elevated about a ground level, according to one or more embodiments.

FIG. 10A illustrates a support stabilizer for stabilizing the base when protruding from a mount such as a hitch receiver of a motorized vehicle such as a truck, according to one or more embodiments.

FIG. 10B illustrates another view of the support stabilizer for stabilizing the base when protruding from a mount such as a hitch receiver of the motorized vehicle, according to one or more embodiments.

FIG. 11 through FIG. 18 illustrate a another specific example of the linear vehicle mount adapted for a motorcycle.

FIG. 11 illustrates a peg retainer device in which the peg of the linear vehicle may be secured in the peg housing through a peg retainer which may be moved over the opening of the peg housing through which the peg of linear vehicle is received, according to one or more embodiments.

FIG. 12 illustrates an example of the peg retainer device of FIG. 11 including a vertical brace assembly (e.g., a left side peg assembly) usable to secure the peg 109A within the peg housing 304A, and FIG. 11 further illustrates a crossmember securing assembly 80 integrated into the vertical brace to move a brace shelf into an engaged position to secure a two wheeled vehicle such as a motorcycle, according to one or more embodiments.

FIG. 13 illustrates another vertical brace assembly (e.g., a right side brace assembly) usable to secure the peg within the peg housing, and further illustrates adjustable brace shelf for receiving the crossmember, including as may be engaged or disengaged with the crossmember securing assembly of FIG. 13, according to one or more embodiments.

FIG. 14 illustrates a vertical brace sheet folding plan for sheet metal usable to construct the vertical brace of FIG. 12, according to one or more embodiments.

FIG. 15 illustrates a vertical brace sheet folding plan for sheet metal usable to construct the vertical brace of FIG. 13, according to one or more embodiments.

FIG. 16 illustrates an example prototype of the embodiment of FIG. 12, with the engagement arm for the peg retainer shown in a disengaged position, and the engagement arm usable to engage the brace shelf shown in a fully disengaged position, according to one or more embodiments.

FIG. 17 illustrates the example prototype of the embodiment of FIG. 16, with the engagement arm for the peg retainer shown in a fully-engaged position, according to one or more embodiments.

FIG. 18 illustrates the example prototype of the embodiment of FIG. 16, with the engagement arm usable to engage the brace shelf shown in a fully-engaged position, according to one or more embodiments.

Other features of the present embodiments will be apparent from the accompanying drawings and from the detailed description that follows.

### DETAILED DESCRIPTION

Disclosed are device, system, and/or method for securing a motorcycle. Although the present embodiments have been described with reference to specific example embodiments, it will be evident that various modifications and changes may be made to these embodiments without departing from the broader spirit and scope of the various embodiments.

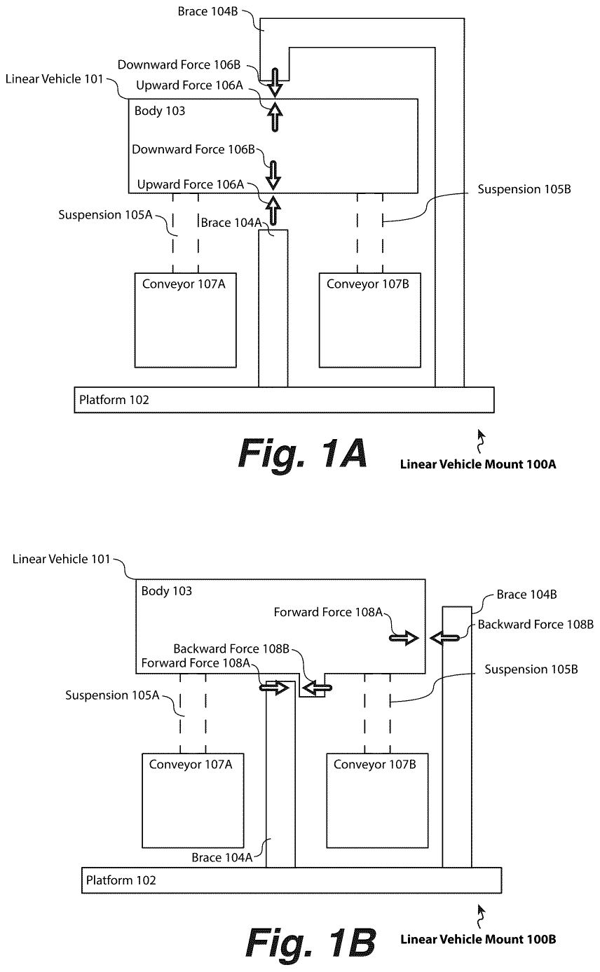

FIG. 1A and FIG. 1B illustrate a linear vehicle mount 100A and a linear vehicle mount 100B, respectively. The term linear vehicle mount 100 as used herein refers to a linear vehicle mount utilizing principles of either the linear vehicle mount 100A and/or the linear vehicle mount 100B.

FIG. 1A illustrates a linear vehicle mount 100A, according to one or more embodiments. A linear vehicle 101 may a linearly balanced vehicle which may include one or more conveyors such as wheels, skids, and/or tracks, that are substantially in-line. For example, a linear vehicle includes a motorcycle, motor bike, dirt bike, snow bike, bicycle, electric bicycle, scooter, a motorized scooter, and/or moped. The linear vehicle may be a motorcycle, which may include a dirt bike, a chopper, a cross bike, an enduro, a cruiser, a touring motorcycle, a street bike, and/or a sport tourist bike, a sport bike. The linear vehicle 101 may include a body 103 (e.g., a chassis, a frame), a suspension 105 that may include two or more elements working alone or in combination such as the suspension 105A and the suspension 105B (e.g., a front and a rear suspension) (e.g., shock absorbers, shocks, springs, forks, pneumatic shock absorbing cylinders, etc.), and/or one or more conveyors 107 (e.g., wheels, skis, skids, tracks).

The linear vehicle mount 100A may include a platform 102 on which the linear vehicle 101 may be positioned. For example, the platform 102 may be a steel plate, aluminum plate, or a surface of a different vehicle such as a truck or trailer bed, and/or a fixed surface such as a floor of a repair shop, garage, retailer store, outdoor sidewalk, and/or parking lot. One or more braces 104 may be coupled to the platform 102, directly or indirectly. In one or more embodiments and the embodiment of FIG. 1A, a brace 104A and a brace 104B protrude from or be otherwise physically coupled with the platform 102. The coupling may occur through one or more brace attachment point, for example fasteners (e.g., bolts), friction fitting components, friction held bracing, etc. The brace 104A may be utilized to apply an upward force 106A on a body 103 of the linear vehicle 101. The brace 104B may be utilized to apply a downward force 106B on the body 103, for example a reaction force opposed to the upward force 106A. As a result, the linear vehicle 101 may be securely held in an upright position. In one or more embodiments, the conveyor 107A and the conveyor 107B may also stay in contact with the platform 102, while the suspension 105A and the suspension 105B are non-compressed and/or minimally compressed relative to existing methods of strapping down the linear vehicle. For example, minimal compression may be three inches or less, an inch or less, a few millimeters or less).

FIG. 1B illustrates a linear vehicle mount 100B. Similarly to the embodiment of FIG. 1A, the linear vehicle mount 100B may include a platform 102 on which the linear vehicle 101 may be positioned, and may also be a stand-alone platform, truck bed, a trailer bed, and/or a fixed surface such as a floor. In one or more embodiments and the embodiment of FIG. 1B, a brace 104A and a brace 104B protrude from or be otherwise physically coupled with the platform 102, for example through one or more brace attachment points. The brace 104A may be utilized to apply an forward force 108A on a body 103 of the linear vehicle 101 (for example on a protrusion of the body 103, as shown, or other solid element coupled to the body 103). The brace 104A and/or the brace 104B may be utilized to apply a backward force 108B on the body 103, for example a reaction force opposed to the forward force 108A. The backward force 108B that is a reaction force may be referred to as a backward reaction force. As a result, the linear vehicle 101 may be securely held in an upright position. In one or more embodiments, the conveyor 107A and the conveyor 107B may also stay in contact with the platform 102, while the suspension 105A and the suspension 105B are non-compressed and/or minimally compressed relative to existing methods of strapping down the linear vehicle.

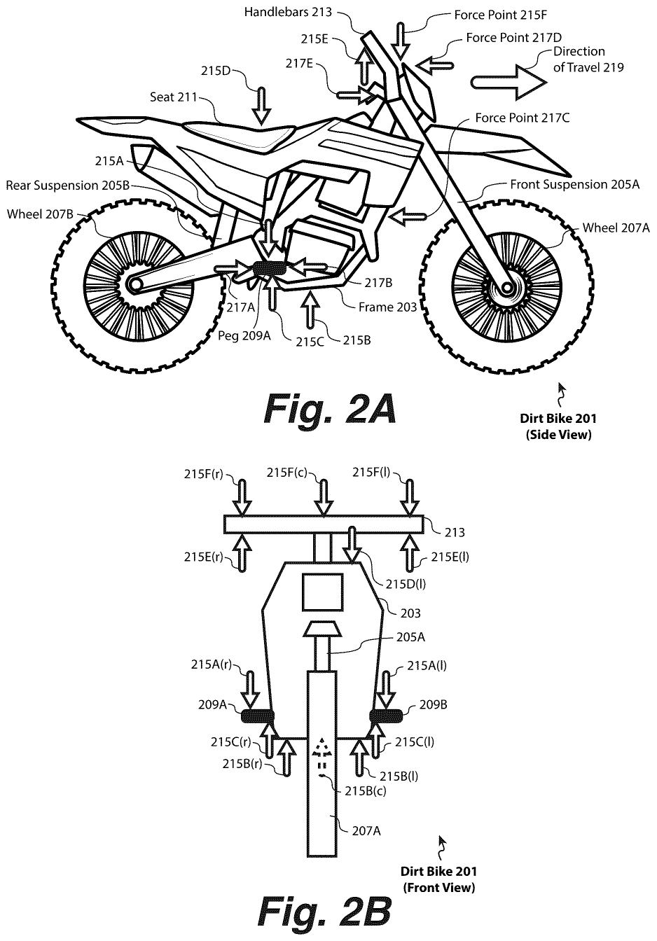

FIG. 2A and FIG. 2B illustrate an example of a linear vehicle 101, a motorcycle, and specifically the dirt bike 201, which can be secured by the linear vehicle mount 100 of FIG. 1, according to one or more embodiments. FIG. 2A illustrates a dirt bike 201 in a side view including a frame 203, a front suspension 205A, a rear suspension 205B, a front wheel 207A, a rear wheel 207B, a peg 209A on a right side of the dirt bike 201 (e.g., a right-side foot peg), a seat 211, and a set of handlebars 213. A direction of travel 219 is illustrated for the dirt bike 201. Also illustrated are a number of force points 215 in which the upward force 106A and/or the downward force 106B can be applied, according to one or more embodiments. In addition, a number of force points 217 in which a forward force 108A or a backward force 108B can be applied, according to one or more embodiments. Each of the force points 215 may be unsuspendedly coupled to the frame 203, that is, connected to the frame 203 without mechanical coupling through a suspension (e.g., the suspension 105, the suspension 205).

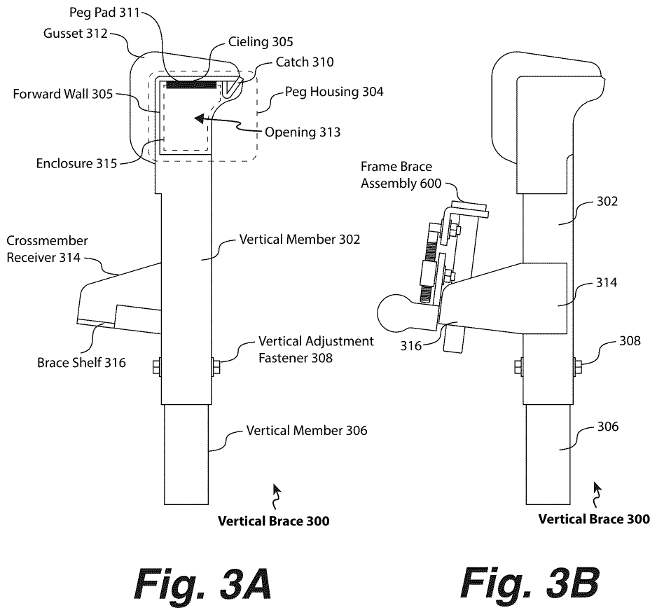

In one or more embodiments, and the embodiment of FIG. 1, the upward force 106A can be applied to the peg 109A at the force point 215C, applied to the frame 203 at the force point 215B, and/or applied to the handlebars 213 at the force point 215E. In one or more embodiments, and the embodiment of FIG. 1, the downward force 106B can be applied to the peg 109A at the force point 215A, to the seat 211 at the force point 215D, to the handlebars 213 at the force point 215F, and/or by pulling downward on the frame 203 (for example at or near the force point 215B but in an opposed and/or opposite force vector). In one or more embodiments, and as shown in the example embodiment of FIG. 3 through FIG. 10, the downward force 106B may be applied to the top side of the peg 209 (both the left peg 209B and right peg 209A) and the upward force 106A may be applied to the frame 203.

Similarly, the forward force 108A can be applied to the peg 109A at the force point 217A, applied to the handlebars 213 at the force point 217E, or at other locations along the frame 203 as will be evident to one skilled in the art. The backward force 108B can be applied to the peg 109A at the force point 217B, the handlebars 213 at the force point 217D, or the frame 203 at the force point 217C.

FIG. 2B illustrates a front view of the dirt bike 201, according to one or more embodiments. FIG. 2B illustrates components visible on the left side of the dirt bike 201, for example the peg 209B. In FIG. 2B, each of the force points 215 are labeled, with an addition “l” or “r” for clarity (designating a left side and right side, respectively), and where “c” designates a centered position relative to the bilateral symmetric of the linear vehicle 101. Note that because the dirt bike 201 is shown from the front, the “right” side of the dirt bike 201 is shown on the left side of FIG. 2B. Multiple instances of the force point 215 may be selected to provide the upward force 106A and/or the downward force 106B. For example, the force point 215F(c) may be selected, which may be at a center point on the handlebars 213, and/or the force point 215F(r) and the force point 215F(1) on each end of the handlebars 213. In one or more embodiments, and as shown in the example embodiment of FIG. 3 through FIG. 10, the downward force 106B may be applied to force point 215A(r) and force point 215A(1), and the upward force 106A may be applied to the force point 215(c) (shown in dashed lines to indicate its position behind the wheel 207A). As further illustrated in FIG. 3A, the downward force 106B may be a reaction force against a ceiling 305 of the peg housing 304. In one or more embodiments, the peg housing 304 may include an opening 313 of the peg housing configured to receive a peg 209 of the motorcycle and a ceiling 395 configured to counteract an upward force of the peg 209 (e.g., the upward force 106A) with a downward reaction force (e.g., the downward force 106B). A suspension of the motorcycle may remains fully relaxed when the upward force 106A from the brace is applied and counteracted by the downward reaction force (e.g., the downward force 106B generated by pushing against the ceiling 305) of the peg housing 304 to protect and improve longevity of the suspension of the motorcycle.

In one or more embodiments, an advantage includes securing the linear vehicle 101 in a secure upright position with a consistent, efficient, and/or quick device, system, and/or method. In one or more embodiments, an advantage includes securing the linear vehicle 101 in a secure upright position without any and/or without a substantial depression of the suspension 105 of the linear vehicle 101. In one or more embodiments, an advantage includes securing the linear vehicle 101 in locked position utilizing a related mechanism as securing the linear vehicle 101 in an upright position, improving theft-resistance and/or improving a strength of the upright security. Numerous other advantages are described throughout the present embodiments.

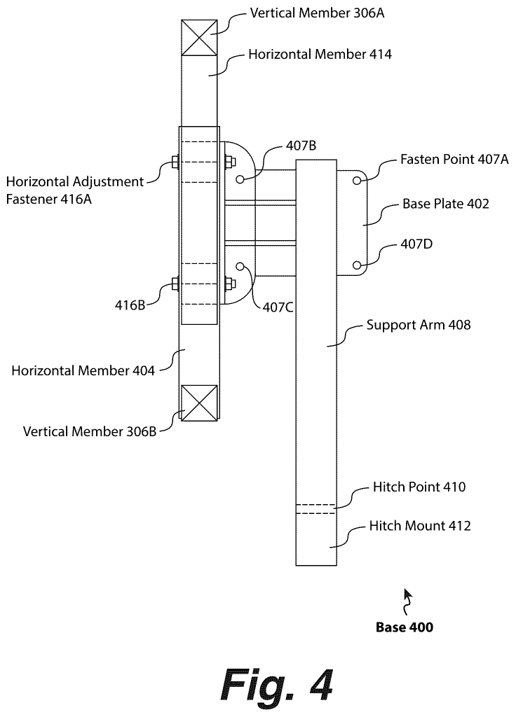

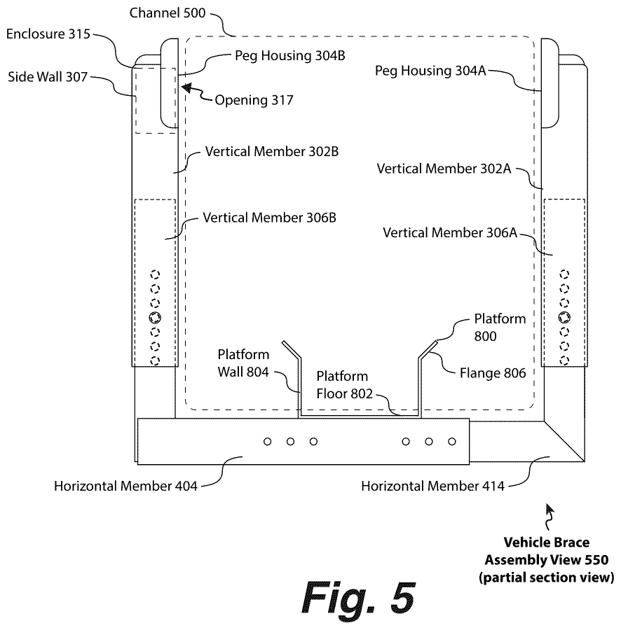

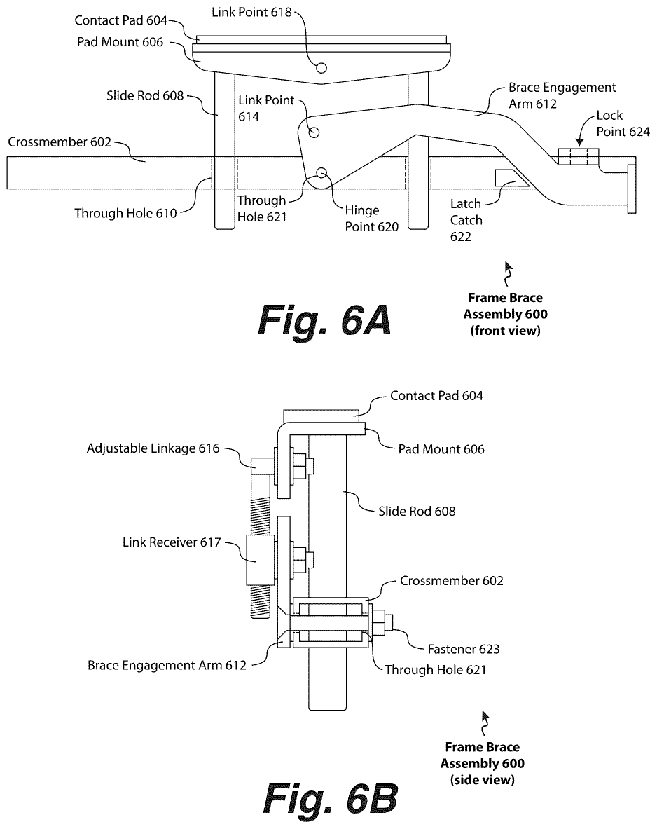

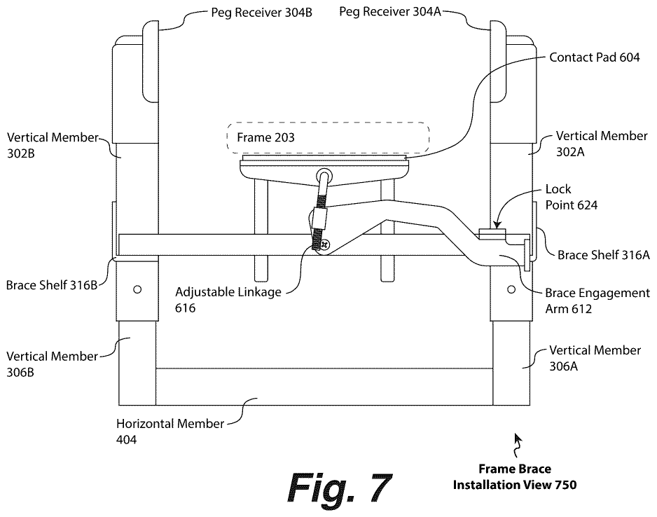

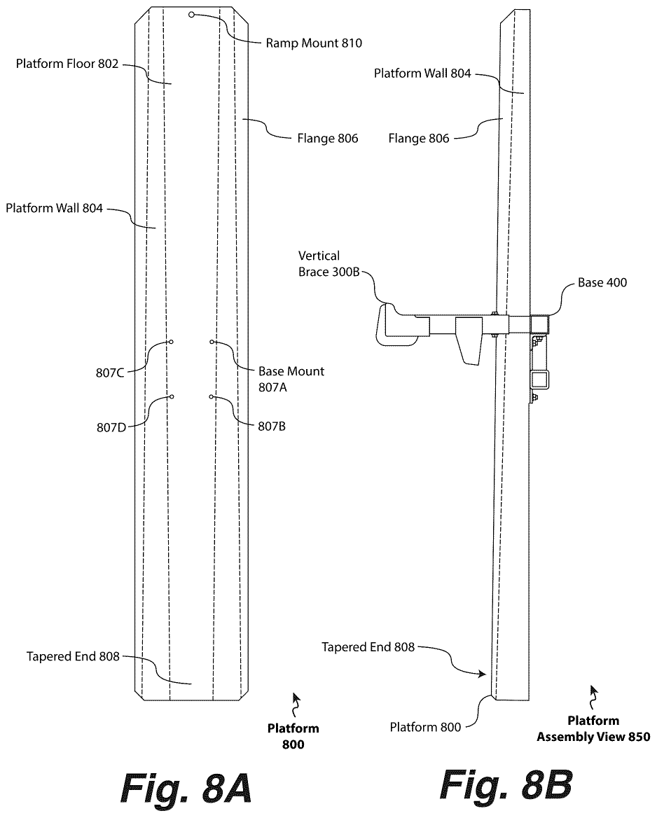

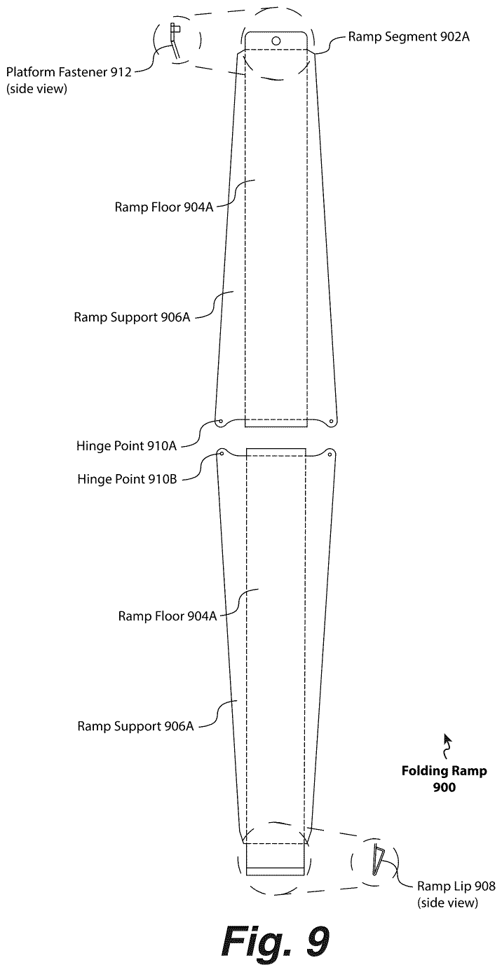

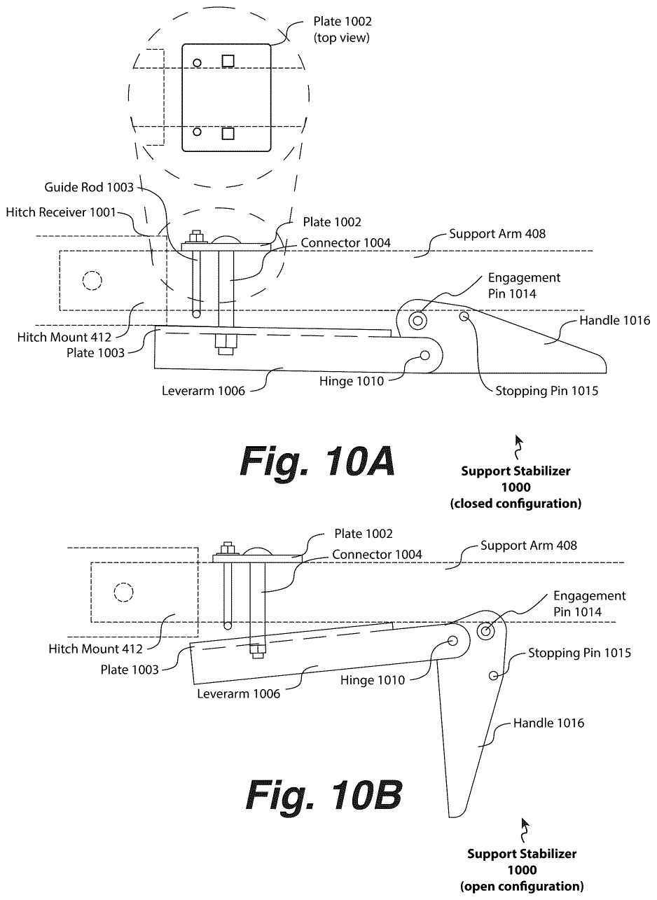

A specific example of the linear vehicle mount 100A is now illustrated in FIG. 3 through FIG. 10, referred to as the linear vehicle mount 150, according to one or more embodiments. The linear vehicle mount 150 may comprise two vertical braces 300 illustrated in FIG. 3, each connected to a base 400 illustrated in FIG. 4 and FIG. 5, supporting a frame brace assembly 600 illustrated in FIG. 6 and FIG. 7, and which can be integrated with a platform 800 of FIG. 8. A folding ramp 900 of FIG. 9 may be utilized to load a linear vehicle 101 onto the platform 800, and the linear vehicle mount 150 may be mounted to a trailer hitch with a support arm 408 that may include a support stabilizer 1000 illustrated in FIG. 10A and FIG. 10B that may further reduce movement or vibration in transport or storage. The linear vehicle mount 150 may be specifically adapted to a motorcycle such as the dirt bike 201, according to one or more embodiments.

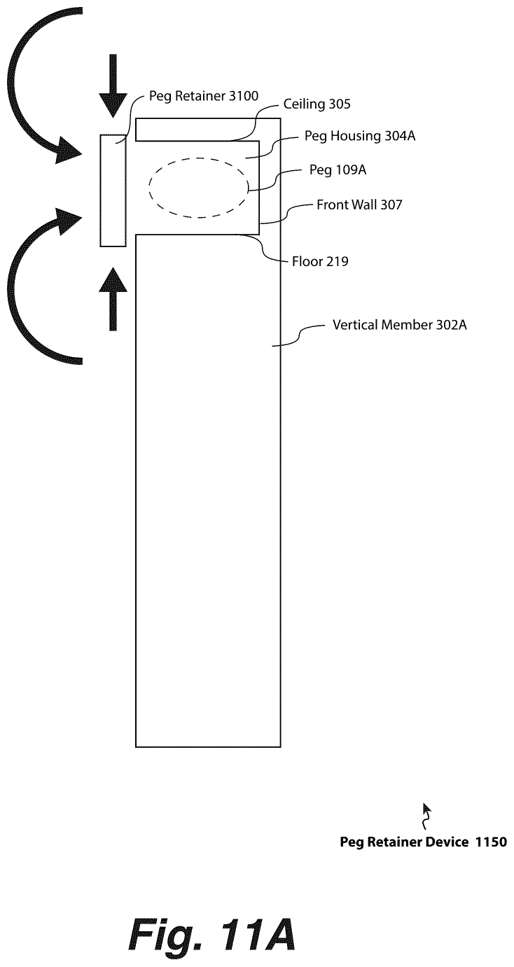

FIG. 3A illustrates a vertical brace 300, and specifically the right-side vertical brace 300, according to one or more embodiments. The vertical brace 300 may include a vertical member 302 that may be made of a suitably strong material such as aluminum or steel. Depending on how heavy the linear vehicle 101 is, the vertical member 302 may be made of a different material, such wood, plastic, and/or carbon fiber. The vertical member 302 may include a peg housing 304 along and/or at a distal end of the vertical member 302. The peg housing 304 may be coupled to the vertical member 302 and/or may be integrated therein. The peg 209 may enter the peg housing 304 though an opening 313. The peg housing 304 may include an enclosure 315, which may be formed partially by a ceiling 305 and a forward wall 307. The peg housing 304 may provide the downward force 106B as an opposing force (which also may be referred to as a reaction force) to the upward force 106A, as further described below. For example, the upward force 106A may push against the ceiling 305. The peg housing 304 may include a catch 310 to help retain the peg 209 in the peg housing 304, including for example without the assistance of the suspension 105. The vertical member 302 may include a gusset 312 for additional strength of the peg housing 304. The peg housing 304 may receive the peg 209 when the linear vehicle 101 is driven, placed, and/or directed along the platform 800. In one or more embodiments, for example as shown and described in conjunction with the embodiments of FIG. 11 through FIG. 18, a peg retainer 1200 may also apply a forward pressure on the peg 209, which may be opposed by a backward force 108B that may be a reaction force of the forward wall 307.

Also illustrated is a peg pad 311, which may be installed in the peg housing 304 for receiving the peg 209, for example to increase friction and/or a coefficient of friction with the peg 209, increase security of the linear vehicle 101, and/or to prevent metal-on-metal contact or scratching between the linear vehicle 101 and the linear vehicle mount 100, according to one or more embodiments. The peg pad 311 may be made of rubber, plastic, wood, leather, or another suitable material. In one or more embodiments, the peg pad 311 may be a friction pad to increase coefficient of friction with the peg 209.

In one or more embodiments, the vertical brace 300 may include a vertical member 306 that may slide on the inside and/or outside of the vertical member 302 for disassembly and/or adjustability. For example, the vertical adjustment fastener 308 may be a bolt or pin sliding through one or more vertical adjustment holes, as shown and described in conjunction with FIG. 5. The vertical member 306 may enable the linear vehicle mount 100 to be adjustable to a linear vehicle 101, such as the dirt bike 201 of almost any height. In one or more embodiments, the peg housing 304 can be adjusted to accommodate heights of various motorcycles, for example such that the suspension 205 is not depressed when the peg 209 is housed in and/or received by the peg housing 304 (the suspension 205 may be momentarily depressed when the peg 209 moves past the catch 310).

The vertical brace 300 may include a crossmember receiver 314 including a brace attachment point, from which the upward force 106A can be applied with the frame brace assembly 600, as further shown and described below and throughout the present embodiments. In one or more embodiments, the brace attachment point may be a brace shelf 316. The crossmember receiver 314 may be similarly made of metal and welded or otherwise sufficiently connected to the vertical member 302. Alternatively, or in addition, it will be recognized that the brace 104 may be coupled with the vertical member 302 and/or the horizontal member 414.

It should be noted that in one or more embodiments, the vertical brace 300 (or a different instance of the brace) may be physically coupled to and/or attached though a brace attachment point to the vertical member 302A, the vertical member 306A, the vertical member 302B, the vertical member 306B, the horizontal member 404, and/or the horizontal member 414.

FIG. 3B illustrates one example of the vertical brace 300, and specifically the left-side vertical brace seen from the outside where an enclosure 315 of the peg housing 304 is not visible. For illustration, the frame brace assembly 600, as further shown and described in conjunction with FIG. 6A, is shown mounted in the crossmember receiver 314. Although one example of a brace 104 is shown, it will be obvious to one in the art that numerous devices, systems, and/or methods may be utilized to brace the motorcycle to provide the upward force 106A, including for example levers that extend up from beneath the motorcycle, hydraulic or mechanical jacks that extend from under the motorcycles, and other similar examples, according to one or more embodiments. For example, in one or more alternate embodiments, a brace 104 for applying the upward force 106A on the linear vehicle may include a frame brace arm coupled to a vertical brace 300 that can be engaged or disengaged to contact a force point on the bottom of the linear vehicle 101 such as the motorcycle. The frame brace arm may include an engagement lever, which when pulled upward into an engaged position mechanically applies force to the frame brace arm, where the frame brace arm may then come into contact with the bottom of the frame 203 of the motorcycle to apply the upward force 106A.

FIG. 4 illustrates a base 400, according to one or more embodiments. The base 400 ma includes a base plate 402 that may be attached to a surface (e.g., a floor, a truck bed, a trailer bed, and/or the platform 800), for example utilizing the fasten point 407A through the fasten point 407D. The base plate 402 may be connected to a horizontal member 404 that may provide spacing for each of the vertical member 306A and the vertical member 306B. Optionally, a second horizontal member may also be utilized, the horizontal member 414, that slide along, into and/or out of the horizontal member 404, for example for disassembly and/or adjustability. A spacing of the vertical member 306A and the vertical member 306B may be achieved through one or more horizontal adjustment fasteners 416, specifically show in FIG. 4 as the horizontal adjustment fastener 416A and the horizontal adjustment fastener 416B. A spacing of the vertical member 306A and the vertical member 306B may adjusted to accommodate a linear vehicle 101 of almost any width.

The base 400 may be coupled to a support arm 408 which may be used to mount and/or suspend the linear vehicle mount 150, for example mounting behind a truck from a trailer hitch. The support arm 408 may include a hitch point 410, shown as dashed lines representing a through-hole, and may include a hitch mount 412 for interfacing with and/or sliding into a trailer hitch receiver (e.g., the hitch receiver 1001 of FIG. 10).

FIG. 5 illustrates vertical brace and base assembly view 550, according to one or more embodiments. The vertical brace and base assembly view 550 illustrates the horizontal member 404 and the horizontal member 414 of the base 400 of the linear vehicle mount 150 from a front view, including integration with the vertical member 302A and the vertical member 302B. The first vertical member 302A and the second vertical member 302B be a fixed distance, optionally adjustable, and form a channel 500 through which the motorcycle may be received. The vertical member 306A and the vertical member 306B adjustably slotted within the vertical member 302A and the vertical member 302B, respectively, are shown in broken lines to demonstrate that the vertical member 306A and the vertical member 306B are hidden from view in FIG. 5. Also illustrated are the enclosure 315, shown in broken lines to illustrate being hidden from view by the forward wall 307 (not labeled). FIG. 5 further illustrates the enclosure 315 may be partially formed by a side wall 309, and include an opening 317 through which the peg 209 may protrude when the motorcycle is secured in the channel 500. Although only one enclosure 315 within the peg housing 304B is shown for context, it will be recognized by one skilled in the art the peg housing 304A also includes an instance of the enclosure 315. FIG. 5 further illustrates that the vertical member 302B and/or the vertical member 306B may run parallel to the vertical member 302A and/or the vertical member 306A, in one or more planes. The vertical member 302B and/or the vertical member 306B, and the vertical member 302A and/or the vertical member 306A, may run may run perpendicular to the horizontal member 404 and/or the horizontal member 414.

FIG. 6A illustrates a front view of the frame brace assembly 600, according to one or more embodiments. The frame brace assembly 600 may include a crossmember 602, which may span the brace shelf 316 of the vertical brace 300A (e.g., the brace shelf 316A) and the brace shelf 316 of the vertical brace 300B (e.g., the brace shelf 316B). A contact pad 604 (that made of rubber, plastic, leather, polymer, or another similarly suitable material) may then adjustably and protrude from the crossmember 602. The contact pad 604 may include a high friction surface to prevent slipping and/or ensure a solid engagement of the contact pad 604 with the frame 203. The contact pad 604 may apply the upward force 106A to the force point 215B. In one or more embodiments and the embodiment of FIG. 6A, the contact pad 604 may be mounted on a pad mount 606 coupled with two slide rods 608 extending through the through holes 610 in the crossmember 602. A brace engagement arm 612 that may rotate on a hinge point 620 may be coupled to the crossmember 602 and may move to extend the contact pad 604 when brought into a position substantially parallel to the crossmember 602. A lock catch 622 may be a protrusion from the crossmember 602 to assist in keeping the brace engagement arm 612 in place unless slight outward pressure is applied by a hand of a user to bypass the lock catch 622.

FIG. 6B illustrates an adjustable linkage 616 coupling a link receiver 617 to the linkage point 614, according to one or more embodiments. In one or more embodiments and the embodiment of FIG. 6B, the adjustable linkage 616 may be a threaded bolt allowing for a distance adjustment reducing and/or increasing an extent to which the contact pad 604 may extend when the brace engagement arm 612 is engaged (e.g., accommodating different heights of the bottom of the frame 203, which may depend on make, model, tire size, frame modification, suspension length, etc). Both the adjustable linkage 616 and the link receiver 617 may rotate around the linkage point 614 and the hinge point 620, respectively, according to one or more embodiments. As illustrated in FIG. 6B, bolts (unlabeled) may be used to attach the adjustable linkage 616 and the link receiver 617, according to one or more embodiments.

The frame brace assembly 600 may also be utilized to lock the linear vehicle 101 in place. As illustrated in FIG. 6A, the lock point 624 may include a flange with a through-hole on both the brace engagement arm 612 and the crossmember 602 (e.g., the lock tab 625A and 625B). A padlock, locking bar, cable, and/or other lock may slide through the through hole to lock the brace engagement arm 612 in an engaged position such that the contact pad 604 remains engaged and the linear vehicle 101 unable to be removed from the linear vehicle mount 150, according to one or more embodiments. In one or more embodiments, although not shown, additional locking points may be utilized, or shields installed to assist in preventing bolt cutters or saws from reaching the lock mechanism and/or tabs. This may provide increased security relative to a cable or chain looped through or otherwise connected to the linear vehicle 101. FIG. 7 is a frame brace installation view 750, according to one or more embodiments. The frame brace assembly 600 is illustrated as installed on the brace shelf 316A and the brace shelf 316B, with the brace engagement arm 612 in an engaged position. It should be noted that in one or more embodiments, and the embodiment of FIG. 7, a single horizontal member 404 that may not be adjustable may be utilized instead.

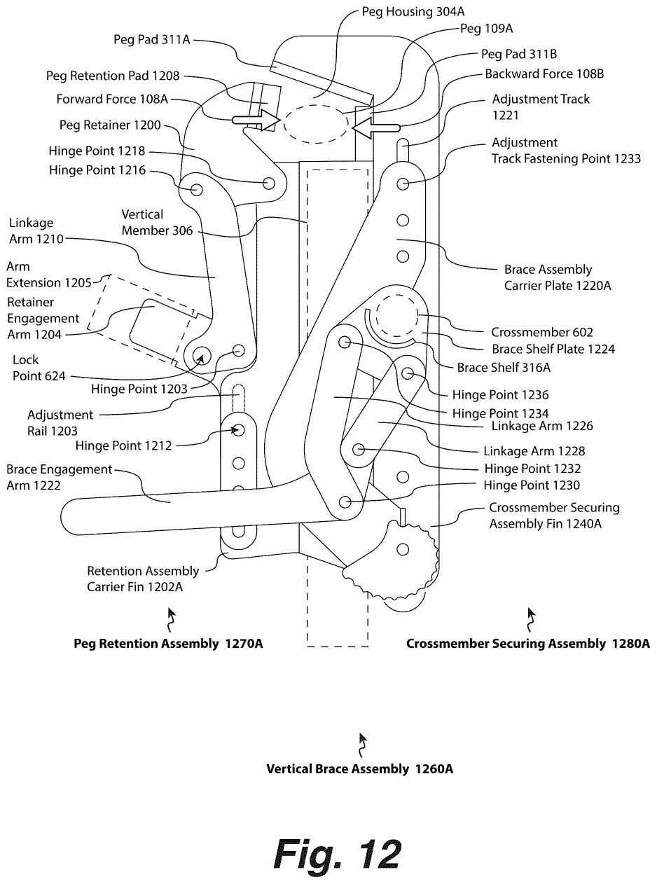

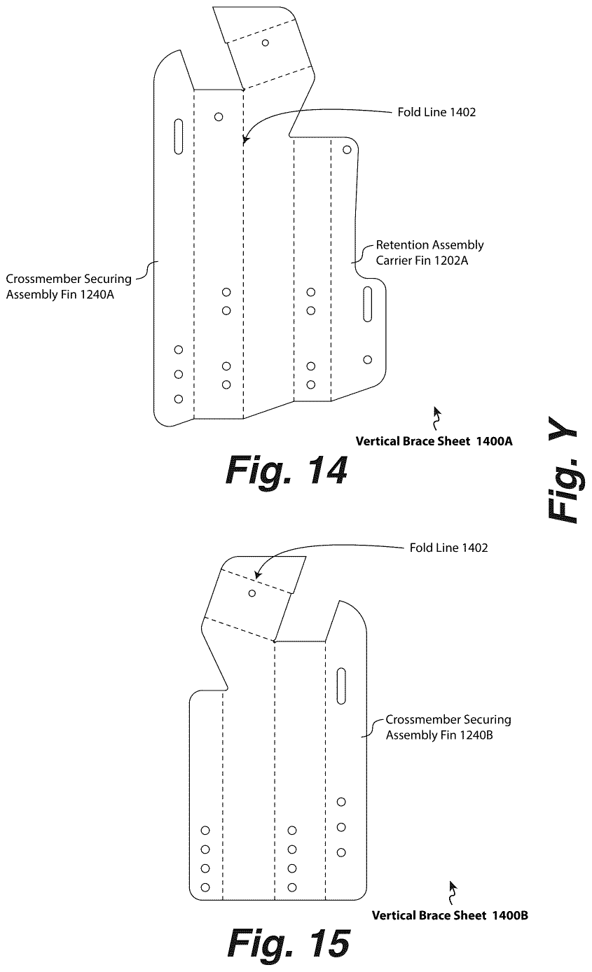

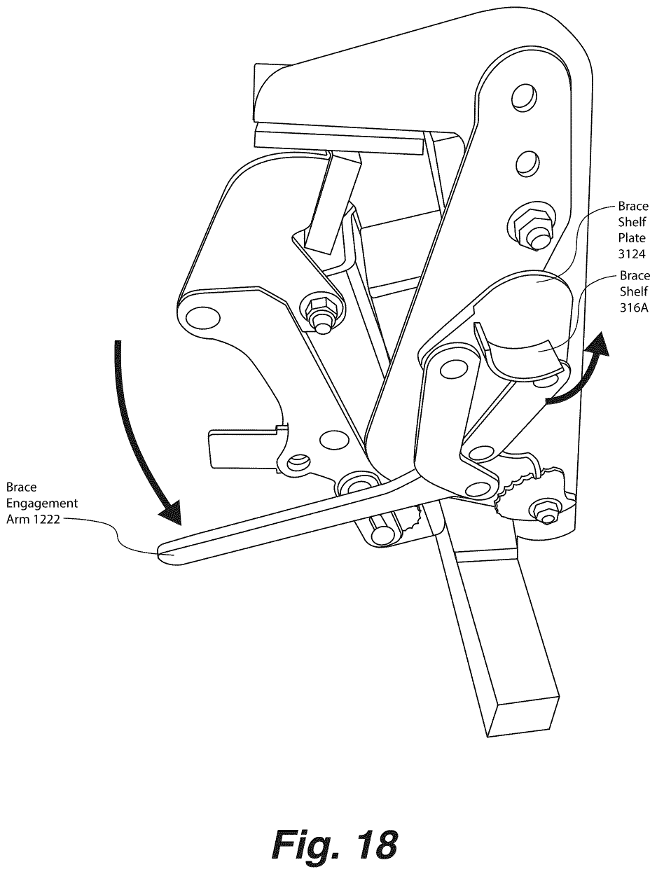

Alternatively, or in addition to the frame brace of FIG. 6A, FIG. 6B, and FIG. 7, the brace 104 may extend toward the motorcycle through mechanical action of the brace shelf 316, for example as shown and described in conjunction with the embodiments of FIG. 12, FIG. 14, and FIG. 18.

FIG. 8A illustrates a platform 800, according to one or more embodiments. The platform 800 may be made from sheet metal that may be folded along the dashed lines to create the platform floor 802, the platform walls 804 (e.g., which may be perpendicular to the platform floor 802 and/or at a slight angle, such as forming a 100 degree to 110 degree angle), and the flange 806. In one or more embodiments, the platform 800 may be tapered, for example resulting in a tapered end 808. The taper may, at the tapered end 808, include a taper in the platform floor 802 and a heighted platform wall 804. The linear vehicle 101 may be guided into the platform 800 from the non-tapered end and moved toward the tapered end 808. The extent of the taper and/or width of the platform 800 may depend on the type, make, and/or model of linear vehicle 100, the type of intended tires or conveyances, and/or other factors. In one or more embodiments, the platform 800 may include mechanisms to assist in the movement of the linear vehicle 101, for example low-friction surfaces and/or stationary wheels helping convey and/or guide the linear vehicle 101.

In one or more embodiments, the platform 800 may be replaceable to accommodate different types of linear vehicle 101, such as different types of motorcycle. Similarly, the vertical members 306 may be replaceable to accommodate different types of linear vehicle 101. In one or more embodiments, an advantage includes a modular system, method, and/or device that can accommodate multiple types of linear vehicle 101, for example that may be owned by the same individual or organization.

The platform 800 may include one or more base mounts, for example the base mount 807A through the base mount 807D that may be utilized to attach to the fasten point 407A through the fasten point 407D, respectively. The platform 800 may further be configured to receive a ramp. For example, the platform 800 may include a ramp mount 810 that may be a through-hole or receiving mechanism for receiving a peg, protrusion, tab, and/or other fastener of the ramp.

FIG. 8B illustrates a side view of the platform 800 and the vertical brace 300B installed on the base 400, according to one or more embodiments.

The platform 800 may be coupled to a ramp such that the linear vehicle 101 such as the motorcycle can be conveyed up the ramp and into the platform when the platform is above ground level (e.g., hitched to a motorized vehicle). The ramp may be folding or non-folding. The folding ramp may have two or more segments.

FIG. 9 illustrates a folding ramp 900 that may be utilized to provide the ramp to the platform 800, according to one or more embodiments. The folding ramp 900 may be made from cut and/or stamped and sheet metal that can be folded. Folds may be made along the dashed lines. A ramp segment 902A may be connected to a ramp segment 902B through a hinge point 910 for example with pins, rods, or bolts. The ramp support 906A may protrude downward perpendicularly from the ramp floor 904A, and similarly the ramp support 906B may protrude downward perpendicularly from the ramp floor 904B. A platform fastener 912 may be attached at one of the non-hinged edges of the ramp segment 902A for interfacing with the ramp mount 810. A ramp lip 908 may be welded, folded over, and/or otherwise attached at a distal end of the ramp segment 902B to provide a smooth transition when conveying the linear vehicle 101 from the ground or other surface to the folding ramp 900 and then onto the platform 800. The folding ramp may be folded and stored in the platform 800 between the wheels of the dirt bike 201, as shown and described in FIG. 21. The ramp may vary in width, or include elements to assist in conveying the linear vehicle 101 up the ramp, for example low-friction surfaces, wheels, and/or one-way surfaces implementing a ratchet mechanism to assist in moving a heavy instance of the linear vehicle 101 against gravity.

FIG. 10A and FIG. 10B illustrate the support stabilizer 1000, according to one or more embodiments. In one or more embodiments and the embodiment of FIG. 10A, the support arm 408 may be configured to mount into a hitch receiver 1001 (e.g., a trailer hitch receiver on a pickup truck, a wall-mounted hitch, a forklift attachment). The support stabilizer 1000 may include a plate 1002 coupled to a plate 1003, for example through one or more bolts. The plate 1002 and the plate 1003 may extend past the support arm 408 such that bolts may connect the plate 1002 and the plate 1003 on the outside of the support arm 408. The plate 1003 may be engaged with the hitch receiver 1001.

FIG. 10A illustrates the support stabilizer 1000 in a closed (e.g., stabilized) configuration, according to one or more embodiments. A leverarm 1006 comprising a plate 1003 (e.g. shown with a broken line) may be coupled to the support arm 408 through the connector 1004 and/or through a different coupler. The handle 1016 may be mechanically coupled to the leverarm 1006 at a hinge 1010, for example through a metal dowel or pin. An engagement pin 1014 may engage the support arm 408 both when the support stabilizer is in an open configuration (e.g., FIG. 3A) and in a closed configuration (e.g., FIG. 3B). A stopping pin 1015 may determine a stopping point for the handle 1016. Natural tension between the plate 1003 and the support arm 408 may result when the handle 1016 is placed in the “closed position”, in turn applying pressure to the side of the leverarm 1006 having the hinge 1010 and again in turn applying pressure on the opposite end of the leverarm 1006 to the hitch mount 412.

FIG. 10B illustrates another instance of the support stabilizer of FIG. 10A, in an open (e.g., disconnected) configuration, according to one or more embodiments.

The support stabilizer 1000 may therefore remove slack or “play” from the connection between the support arm 408 and the hitch receiver 1001. This may be advantageous, especially where the support arm 408 is long, holds an especially heavy instance of the linear vehicle 101 loaded on the linear vehicle mount 150, and/or where a vehicle conveying the hitch receiver 1001 is traversing a rough road. This may further reduce stress and/or compression on a suspension 105.

It will be recognized that many other embodiments are possible. In one or more embodiments, the linear vehicle mount 100 need only provide one of the downward force 106B and the upward force 106A, where the other force may be provided by an environment or other device, system, and/or method. For example, the upward force 106A could be provided by a freestanding jack or ascending wall-mounted arm (e.g., the frame brace arm 2802 attached to a wall), and/or the downward force 106B could be provided by an extendable press from a ceiling and/or descending wall-mounted arm. Such embodiments may be useful for garage, shop, and/or outdoor parking applications.

In one or more embodiments, it will be appreciated there may be multiple ways of providing both the upward force 106A and the downward force 106B. For example, for the example embodiment of FIG. 3A through FIG. 10, the vertical brace 300 could be replaced by the peg brace 2500 such that the upward force 106A can be provided by both the peg brace 2500 and/or the frame brace assembly 600, according to one or more embodiments.

In one or more other embodiments, it will be appreciated that no platform 102, platform 800 and/or folding ramp 900 are needed or utilized. For example, the brace 104A and the brace 104B (e.g., the vertical brace 300A and the vertical brace 300B) may extend directly out from a concrete surface and can be used as a stand or lockable storage for the linear vehicle 101.

In one or more embodiments, it will be appreciated that the frame brace assembly 600 may rest on a different location than the brace shelf 316, for example on the base 400 and/or on shelves that may be fabricated on the platform 800, for example along the flange 806. In one or more other embodiments, a different mechanism than the frame brace assembly 600 may be utilized, for example a lockable jack placed on the platform floor 802 and that expendably spans up to the body 103 of the linear vehicle (e.g., the frame 203 of a dirt bike 201).

In one or more embodiments, a method includes (i) placing a linear vehicle on a platform (e.g., the platform 800), (ii) applying with a first brace (e.g., the vertical brace 300) coupled to the platform a downward force 106B on a first point that is at least one of a frame (e.g., the body 103) of the linear vehicle 101 and a point unsuspendedly coupled to the frame (e.g., the force point 215A); and (iii) applying with a second brace coupled (e.g., the frame brace assembly 600) to the platform an upward force 106A on a second point that is at least one of a frame of the linear vehicle 101 and a point unsuspendedly coupled to the frame (e.g., the force point 215B), where the suspension of the linear vehicle 101 (e.g., the suspension 205 of the dirt bike 201) remains fully relaxed when the downward force 106B and the upward force 106A are applied.

In one or more embodiments, a method includes adjusting a horizontal width of two braces 104 (e.g., the vertical braces 300) to accommodate a width of a linear vehicle, adjusting a vertical height of the two braces 104 (e.g., the vertical braces 300) to accommodate the appropriate force point 215 for the type of force application mechanism (e.g., adjusting a height of the vertical braces 300 such that the peg housing 304 receives the peg 209 without depression of the suspension 205), loading a linear vehicle on a platform 102, positioning a third brace 104 (e.g., a frame brace assembly 600) immovably with respect to the braces 104 and engaging the third brace 104 (e.g., engaging the frame brace assembly 600), optionally storing an accessory (e.g., the folding ramp 900), and optionally locking the a lock point (e.g., the lock point 624) to secure and/or protect the linear vehicle 101 from unauthorized movement or theft. In one or more embodiments, prior to or following the first operation of such method, a mount (e.g., the support arm 408) may be mounted to a receiver (e.g., the hitch receiver 1001), and optionally a stabilizer (e.g., a support stabilizer 1000) may be employed to snug, secure, and/or remove “play” from the mounted connection.

A specific example of the linear vehicle mount 100 is now illustrated in FIG. 11 through FIG. 18, referred to as the linear vehicle mount 150B, according to one or more embodiments. Elements not show may use like or similar elements from the linear vehicle mount 150B, for example the embodiment of FIG. 4, FIG. 5, FIG. 8A, FIG. 8B, FIG. 9, FIG. 10A, and FIG. 10B.

FIG. 11A illustrates a peg retainer device 1150 in which the peg 109 of the linear vehicle 101 may be secured in the peg housing 304A through a peg retainer 1100 which may be moved over and/or block the opening of the peg housing 304A through which the peg 109 of linear vehicle 101 is received, according to one or more embodiments. As illustrated, the peg retainer 1100 may utilize many mechanisms to move down over the opening of the peg housing 304, for example hinging on one edge down over the opening, hinging on one edge up over the opening, sliding down into place, and/or sliding up into place. It will be recognized by one skilled in the art that the hinge point may allow for hinging “into” or “out of” the page of the present view, and/or may slide “into” or “out of” the page of the present view. The peg retainer device 1250 may assist in holding the linear vehicle 101 in place without depression of the suspension 105, and may be used with our without the upward force 106. However, in one or more preferred embodiments the upward force 106 is also utilized. The peg retainer device 1250 may further assist in holding the linear vehicle 101 in place on bumpy roads or other locations in which the vehicle to which the linear vehicle mount 100 is attached may cause substantial shaking or vibration in the linear vehicle mount 100, which could cause the suspension 105 to depress and the peg 109 to “jump out” of the peg housing 304. An example implementation of the peg retainer device 1150 will now be described.

FIG. 12 illustrates a vertical brace assembly 1260A (e.g., a left side peg assembly) comprising a peg retention assembly 1270A usable to secure the peg 109A within the peg housing 304, and further illustrates a crossmember securing assembly 1280A integrated into the vertical brace 300 to move a brace shelf 316A into an engaged position to secure the linear vehicle 101 and/or motorcycle such as the dirt bike 201, according to one or more embodiments. The vertical brace assembly 1260A may include an adjustment plate 1206, a retainer engagement arm 1204 that may hinge on a hinge point 1212 and a hinge point 1214, a linkage arm 1210 that may hinge on a hinge point 1214 and a hinge point 1216, a peg retainer 1200 that may hinge on a hinge point 1216 and a hinge point 1218, and a peg retention pad 1208. As will be evident to one skilled in the art from FIG. 12, the peg retention assembly 1270A may, then the retainer engagement arm 1204 is fully engaged, “cam over” such that force on the linkage arm 1210 is applied at such an angle as to not disgorge the retainer engagement arm 1204 (e.g., rather, such force may further encourage engagement of the retainer engagement arm 1204).

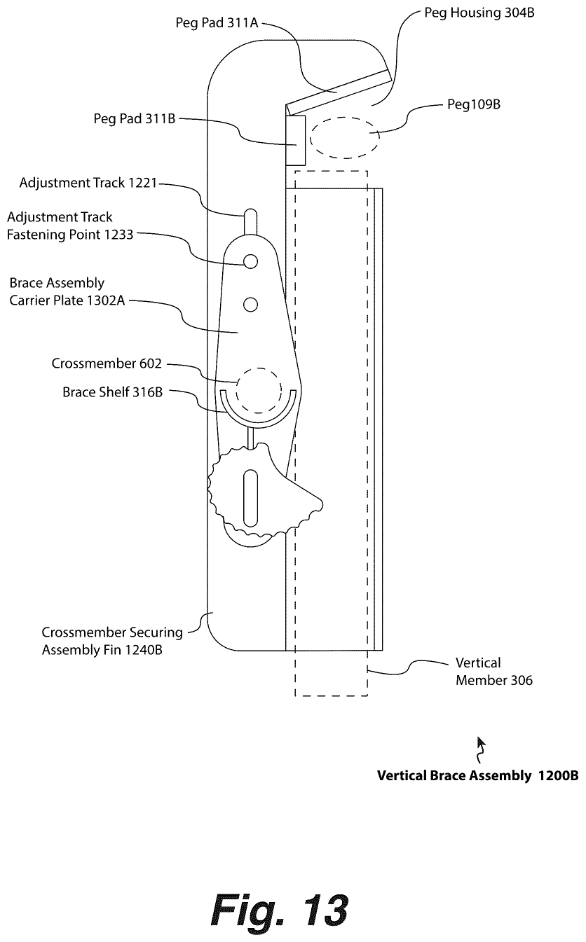

The peg retention assembly 1270A may include and/or may couple to a retention assembly carrier fin 1202 which may be manufactured as a single piece of the vertical brace 300 (e.g., as shown in FIG. 13) and/or may be attachable. An adjustment track 1203 may allow for vertical adjustment of the components engaging the peg retention pad 1208, and an adjustment plate 1201 which may be adjustably installed along the adjustment track 1203 and secured with a through-bolt or other fastener. A through-hole of the adjustment plate 1201 may act as a hinge point 1212 for the retainer engagement arm 1204. The unlabeled through-holes below the hinge point 1212 may be used for tightened fastening.

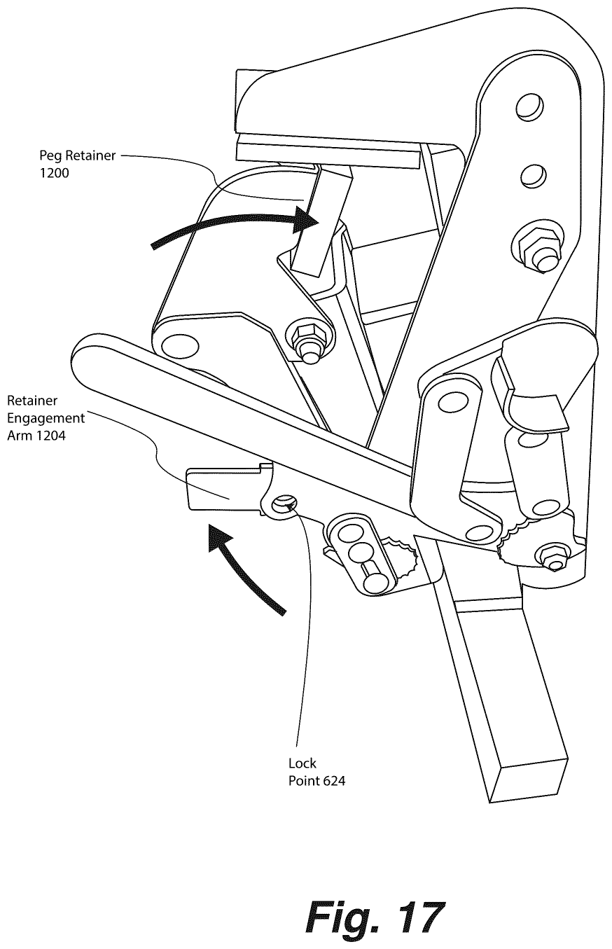

The retainer engagement arm 1204 may rotate around the hinge point 1212 to act as a lever engaging the linkage arm 1210 that may be coupled to the retainer engagement arm 1204 and which may rotate around the hinge point 1214. The linkage arm 1210 may in turn be coupled to the peg retainer 1200 at the hinge point 1216, and the peg retainer 1200 may be coupled to the retention assembly carrier fin 1202 at the hinge point 1218. Upon the user engaging the retainer engagement arm 1204 (e.g., pulling ‘upward’ on the retainer engagement arm 1204), the peg retainer 1200 may rotate into an engagement position such that the peg retention pad 1208 may enclose and/or secure the peg 109A with the forward force 108A in the peg housing 304. The engagement process of the retainer engagement arm 1204 and the peg retainer 1200 is illustrated in the prototype of FIG. 17 and FIG. 18. An additional arm extension 1205, shown in broken lines, may be added by the user (e.g., as required or at the preference of the user) to increase leverage on the retainer engagement arm 1204. In one or more embodiments, the crossmember 602 may include a hollow into the interior (e.g., may be made from a piece of bar stock) such that it may be fit over the retainer engagement arm 1204 or tip thereof and act as the arm extension 1205. As further shown and described below in FIG. 18, the lock point 624 may align with another through-hole of the retainer engagement arm 1204 when the retainer engagement arm 1204 is fully engaged (an example of such through-hole is shown in FIG. 18), and the user may place a lock through the lock point 624 (e.g., a padlock, a bike lock, etc.).

The present configuration may provide a relatively compact linkage, sufficient leverage for an average user to engage the ped retention carrier, and sufficient prevent the peg 109A from forcing the ped retention pad backward when bouncing around when hitched to a vehicle (e.g., a truck), even if the lock point 624 is not utilized, for example due to the forward force 108A and the cam over of the peg retention assembly 1270. However, one of the teachings herein will be recognized to include surrounding the peg 109A within the peg housing 304 and/or engaging the peg 109 (e.g., without depressing the suspension 205) to secure the linear vehicle 101. Many other mechanisms are contemplated hereby to move the peg retainer 1200 into place when the peg 109A is properly positioned and/or to apply the forward force 108A.

FIG. 12 further illustrates a crossmember securing assembly 1280A comprising a brace assembly carrier plate 1220, a brace shelf plate 1224 including the brace shelf 316, the brace engagement arm 1222, the linkage arm 1226, the linkage arm 1228, the hinge point 1230, the hinge point 1232, the hinge point 1234, and the hinge point 1234. The crossmember securing assembly may be adjusted vertically along the adjustment track 1221 which may be similarly set in a turned-out fin of the vertical brace 300. A fastener may be put through an adjustment track fastening point 1233 and the adjustment track 1221 to secure the crossmember securing assembly at a vertical location. The vertical location may be set depending on a contact point (e.g., force point 215) on the underside of the linear vehicle 101 (e.g., the point of contact of the frame 203 of FIG. 2A). When the brace engagement arm 1222 is engaging, the brace engagement arm 1222 may pivot about the hinge point 1230, causing rotation in the linkage arm 1226 and the linkage arm 1228 around the hinge point 1230 and the hinge point 1232, respectively. As a result, the brace shelf plate 1224 may rotate around the hinge point 1234 until the brace shelf 316 rotates upward to securely position the crossmember 602. As will be evident to one skilled in the art, the crossmember securing assembly may cam over such that downward force on the brace shelf 316A applies force at such an angle that the brace engagement arm 1222 as to not disgorge the brace engagement arm 1222 (e.g., rather, such force may further encourage engagement of the brace engagement arm 1222). The engagement process of the retainer engagement arm 1204 and the peg retainer 1200 is illustrated in the prototype of FIG. 18.

The vertical brace assembly 1260A may also include additional padding inside the peg housing 304A, for example the peg pad 1600A and the peg pad 1600B on the top and back portions of the peg housing 304, respectively.

FIG. 13 illustrates another vertical brace assembly 1260B (e.g., a right-side brace assembly) usable to secure the peg 209B within the peg housing 304B, and further illustrates adjustable brace shelf 316B for receiving the crossmember 602, including as may be engaged or disengaged with the crossmember securing assembly 1280 of FIG. 12, according to one or more embodiments. Specifically, the vertical brace assembly 1260B may include a crossmember securing assembly 1280B, which may be adjusted to and set at a static height such that the brace shelf 316B matches the height of the brace shelf 316A when the brace shelf 316A is in the “engaged” position, as shown and described in conjunction with FIG. 12 and FIG. 18. As illustrated, the peg housing 304B need not be includes by a peg retainer 1200. However, in one or more embodiments, and especially if no upward force 106 is provided, the peg retention assembly 1270A may be replicated or mirrored such that both the peg 109A and the peg 109B are secured by a peg retainer 1200 (e.g., a peg retainer 1200A and a peg retainer 1200, respectively).

FIG. 14 illustrates a vertical brace sheet 1400 folding plan for sheet metal usable to construct the vertical brace of FIG. 12, according to one or more embodiments. Broken lines indicate a location for folding, e.g., a fold line 3202. The vertical brace sheet 1400A may be cut or stamped steel. The crossmember securing assembly fin 1240A and the retention assembly fin 1202A are illustrated on either side.

FIG. 15 illustrates a vertical brace sheet folding plan for sheet metal usable to construct the vertical brace assembly 1260B of FIG. 33, according to one or more embodiments. Broken lines indicate a location for folding. The vertical brace sheet 1400A may be cut or stamped steel. The crossmember securing assembly fin 1240B is illustrated on one side.

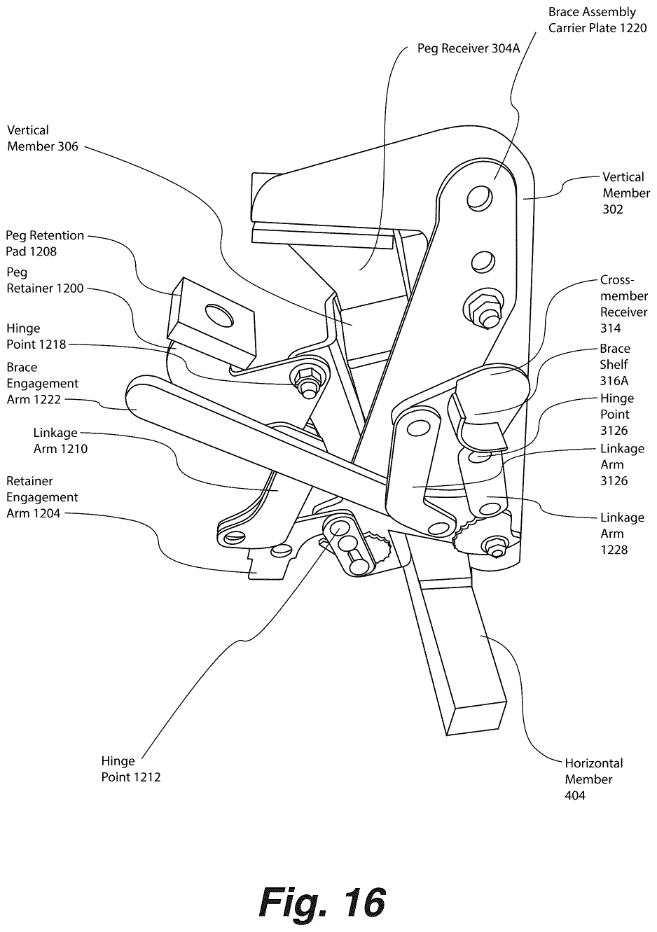

FIG. 16 illustrates an example prototype of the embodiment of FIG. 12, with the retainer engagement arm 1204 for the peg retainer 1200 shown in a disengaged position and the brace engagement arm 1222 usable to engage the brace shelf 316B shown in a disengaged position, according to one or more embodiments. FIG. 17 illustrates the example prototype of the embodiment of FIG. 16, with the engagement arm for the peg retainer 1200 shown in a fully-engaged position, according to one or more embodiments. A directionality of travel of the retainer engagement arm 1204 and the resulting imparted directionality of travel of the peg retainer 1200 and the forward force 108A are further illustrated with arrows. As will be evident to one skilled in the art, the peg retainer 1200 is shown cammed over to assist in the peg retainer 1200 remaining in an engaged position. The peg retainer 1200 and the retainer engagement arm 1204 are shown in their final resting positions for engagement in the embodiment of FIG. 17. The lock point 624 is shown established such that a lock, cotter pin, clevis, or other protrusion can be placed through the lock point 624, for physical security (e.g., to prevent the linear vehicle 101 from being stolen) and integrity (e.g., to ensure the retainer engagement arm 1204 stays engaged and therefore the peg retainer 1200 stays engaged).

FIG. 18 illustrates the example prototype of the embodiment of FIG. 16, with the brace engagement arm 1222 usable to engage the brace shelf 126B, the brace engagement arm 1222 shown in a fully-engaged position, according to one or more embodiments. A directionality of travel of the brace engagement arm 1222 and the resulting imparted directionality of travel of the brace shelf place 316 and brace shelf 316 are further illustrated with arrows. As will be evident to one skilled in the art, the brace shelf plate 1224, the linkage arm 1226, the linkage arm 1228, and the brace engagement arm 1222 is shown cammed over to assist in the peg retainer 1200 remaining in an engaged position. The brace shelf 316B and the brace engagement arm 1222 are shown in their final resting positions for engagement in the embodiment of FIG. 17.

In one or more embodiments, a method of securing a linear vehicle 101 includes placing the linear vehicle on a platform; placing a peg 109 of the linear vehicle 101 (e.g., a peg 109A and/or a peg 109B protruding from the sides of the linear vehicle 101) in a peg housing 304 (e.g., a peg housing 304A, a peg housing 304B) open at least one side; and covering the at least one side with a peg retainer 1200 (e.g., a peg retainer 1200A, a peg retainer 1200B), where a suspension of the linear vehicle 101 remains fully relaxed when the peg 109 is contained by the peg housing 304 and the peg retainer 1200. Additional upward force 106A and/or downward force 106B may be added for further security as well.

In one or more embodiments, principals of the linear vehicle mount 100A and the linear vehicle mount 100B may be combined, for example apply both an upward force 106A on an element of the linear vehicle (e.g., a peg 209 of a motorcycle) and a forward force 108A. The element may be trapped in an enclosure (e.g., the enclosure 309) with a ceiling 305 and a forward wall 307, which may apply reaction forces including a downward force 106B and a backward force 108B. As a result, the element of the linear vehicle (e.g., the peg 209) may be pushed into a upper-forward corner of the enclosure 309, which may assist in retaining the linear vehicle 101 such as the motorcycle without engaging the suspension 105. Although a forward force 108A is described as an imparted force and a backward force 108B as a reaction force, it will be obvious to one skilled in the art that the backward force 108B may be imported and the forward force 108A may be the reaction force.

Although the present embodiments have been described with reference to specific example embodiments, it will be evident that various modifications and changes may be made to these embodiments without departing from the broader spirit and scope of the various embodiments.

In addition, the process flows described or logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

Embodiments of the invention are discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Unless defined otherwise, all technical, engineering, and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems.

Features which are described in the context of separate embodiments may also be provided in combination in a single embodiment. Conversely, various features which are, for brevity, described in the context of a single embodiment, may also be provided separately or in any suitable sub-combination. The applicants hereby give notice that new claims may be formulated to such features and/or combinations of such features during the prosecution of the present application or of any further application derived therefrom.

References to “one embodiment,” “an embodiment,” “example embodiment,” “various embodiments,” “one or more embodiments,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least one or more embodiments of the invention” includes the stated particular feature, structure, or characteristic.

The enumerated listing of items does not imply that any or all of the items are mutually exclusive, unless expressly specified otherwise.

It is understood that the use of a specific component, device and/or parameter names are for example only and not meant to imply any limitations on the invention. The invention may thus be implemented with different nomenclature and/or terminology utilized to describe the mechanisms, units, structures, components, devices, parameters and/or elements herein, without limitation. Each term utilized herein is to be given its broadest interpretation given the context in which that term is utilized.

A description of an embodiment with several components in physical communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Any abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A device for securing a motorcycle, the device comprising:
a horizontal member,
a first vertical member coupled to the horizontal member,
a peg housing at least one of coupled to and integrated into the first vertical member,
wherein the peg housing comprising an opening of the peg housing configured to receive a peg of the motorcycle and a ceiling configured to counteract an upward force of the peg with a downward reaction force, and
a first brace attachment point coupled to at least one of the horizontal member and the first vertical member, the first brace attachment point configured to receive a brace usable to generate an upward force on the motorcycle,
wherein a suspension of the motorcycle remains fully relaxed when the upward force from the brace is applied and counteracted by the downward reaction force of the peg housing to protect and improve longevity of the suspension of the motorcycle.

2. The device of claim 1, further comprising:
a second vertical member coupled to the horizontal member and running parallel to the first vertical member such that a channel is formed between the first vertical member and the second vertical member for receiving the motorcycle, and
wherein the peg housing further comprising a forward wall for at least one of holding the peg of the motorcycle in the peg housing prior to application of the upward force and further assisting in retaining the peg of the motorcycle in the peg housing.

3. The device of claim 1, further comprising:
a peg retainer mechanically coupled to at least one of the horizontal member and the first vertical member comprising a peg retention pad engageable to at least one of cover an opening of the peg housing through which the peg is received and apply a forward force on the peg to counteract the forward force with a backward reaction force, to assist in retaining the peg of the motorcycle in the peg housing and dis-engageable to uncover the opening for removal of the peg from the peg housing.

4. The device of claim 3, wherein the peg retainer further comprising:
a first hinge rotatably hinging about a first hinge point coupled with the first vertical member to rotate the peg retention pad until at least one of blocking the opening and applying the forward force.

5. The device of claim 2, wherein the brace attachment point adjustably coupled to at least one of the first vertical member and the horizontal member, the device further comprising:
a brace engagement arm mechanically coupled to the brace attachment point that when the brace engagement arm is engaged engages the brace attachment point to apply an upward force to the brace.

6. The device of claim 5, wherein at least one of the peg housing and the first vertical member configured to vertically adjust relative to the horizontal member to accommodate a height of the peg of the motorcycle.

7. The device of claim 5,
wherein the first brace attachment point is mechanically coupled to the vertical member, and a second brace attachment point is coupled to the second vertical member,
wherein the first brace attachment point comprising a first brace shelf for receiving a first end of a crossmember of the brace and the second brace attachment point comprising a second brace shelf for receiving a second end of the crossmember of the brace,
wherein the brace engagement arm mechanically coupled to the brace attachment point through a set of one or more hinges comprising a second hinge, and
wherein engagement of the brace engagement arm rotates the first brace attachment point upward rotatably around the second hinge to apply the upward force to the brace.

8. The device of claim 7, further comprising:
a brace assembly mechanically coupled to the first vertical member comprising the brace attachment point, the one or more hinges, and the brace engagement arm,
wherein the brace assembly mechanically coupled to the first vertical member to adjust a vertical position along the first vertical member to accommodate a height of a force point of the motorcycle,
wherein at least one of the horizontal member, a coupling between the horizontal member and the first vertical member, and a coupling between the horizontal member and the second vertical member configured to adjust a distance between the first vertical member and the second vertical member to accommodate a width of the motorcycle,
a platform coupled to and running perpendicular to the horizontal member, the platform extending between the first vertical member and the second vertical member for receiving wheels of the motorcycle,
a hitch mount coupled to at least one of the horizontal member, the first vertical member, and the second vertical member for mounting the device to a hitch receiver of a motorized vehicle,
a ramp coupled to the platform for enabling the motorcycle to be wheeled onto the platform when the platform is elevated from a ground level,
a friction pad coupled to the ceiling for increasing a coefficient of friction with the peg when receiving the upward force from the peg and imparting the downward reaction force to the peg,
wherein the peg retainer comprising a first lock point comprising a through hole through which at least one of a lock and a cotter pin can be positioned to lock the peg retainer in the engaged position for improved security of the motorcycle during at least one of storage and transport, and
wherein the motorcycle is at least one of a sport bike and a dirt bike.

9. An apparatus for securing a peg of a motorcycle, the apparatus comprising:
a member extending a first length,
a peg housing at least one of coupled to the member and integrated into the member comprising an enclosure comprising a first opening on one side configured to receive a peg of the motorcycle from a direction of travel of the motorcycle and a second opening facing the motorcycle through which the peg protrudes when the peg is housed in the enclosure,
wherein the encloser comprising a ceiling and a forward wall, and
a peg retainer mechanically coupled to the member comprising a peg retention pad engageable to cover the first opening of the peg to apply a forward force on the peg counteracted by a backward reaction force from the forward wall, to assist in retaining the peg of the motorcycle in the peg retainer,
wherein the motorcycle is at least one of a sport bike and a dirt bike.

10. The apparatus of claim 9, further comprising:
a peg retention assembly coupled to the member, comprising:
the peg retainer,
a first hinge rotatably hinging about a first hinge point coupled with the member to engage the peg retention pad over the first opening, and
a retainer engagement arm mechanically coupled to the peg retainer such that engagement of the retainer engagement arm rotates the peg retainer around the first hinge point to engage the peg retention pad until applying the forward force.

11. The apparatus of claim 10, wherein the peg retention assembly further comprising:
one or more linkage arms mechanically coupling the retainer engagement arm with the peg retainer configured to cam over such that at least one of the backward reaction force and a different backward force further engages the retainer engagement arm, and
a first lock point comprising a through hole extending through, when the peg retainer is engaged, at least two of the member, the peg retainer, one of the one or more linkage arms, and the retainer engagement arm, for receiving at least one of a lock and a cotter pin to lock the peg retainer in the engaged position during at least one of storage of the motorcycle and transport of the motorcycle.

12. The apparatus of claim 11, further comprising:
a brace assembly coupled to the member configured to apply an upward force on a force point of the motorcycle,
wherein the ceiling configured to counteract with a downward reaction force an upward force applied to the peg resulting from the upward force on the force point, and
wherein a suspension of the motorcycle remains fully relaxed when the upward force from the brace is applied and counteracted by the downward reaction force of the peg housing to protect and improve longevity of the suspension.

13. The apparatus of claim 12, further comprising:
a friction pad coupled to the ceiling for increasing a coefficient of friction with the peg when receiving the upward force from the peg and imparting the downward reaction force.

14. The apparatus of claim 13, wherein the brace assembly further comprising:
a brace shelf plate comprising brace shelf for receiving a first end of a crossmember,
a second hinge rotatably hinging about a second hinge point coupled with the member to engage the brace shelf plate,
a brace engagement arm mechanically coupled to the brace shelf plate that when engaged rotates the brace shelf plate upward around the second hinge point to apply the upward force, and
one or more linkage arms mechanically coupling the brace shelf plate to the brace engagement arm configured to cam over such that at least one of the downward reaction force and a different downward force further engages the brace engagement arm.

15. The apparatus of claim 14, further comprising:
an adjustment track comprising at least two adjustment positions for adjusting a position of the brace assembly along the member for accommodating a height of the force point of the motorcycle,
wherein the brace assembly further comprising a second lock point comprising a through hole extending through at least two of the member, the brace shelf plate, one of the one or more linkage arms, and the brace engagement arm, when the brace is engaged, for receiving at least one of a different lock and a different cotter pin to lock the brace in the engaged position during at least one of storage of the motorcycle and transport of the motorcycle, and
wherein the motorcycle is at least one of a sport bike and a dirt bike.

16. A rack for securing a bike, comprising:
a first peg housing for receiving a first peg of the motorcycle comprising a first encloser,
a second peg housing coupled to the first peg housing at a fixed distance for receiving a second peg of the motorcycle comprising a second enclosure,
a brace coupled to the first peg housing and the second peg housing for applying an upward force on the motorcycle, and
wherein the first peg housing and the second peg housing configured to resist the upward force with a downward reaction force to secure the motorcycle in the rack while minimizing depression of a suspension of the motorcycle.

17. The rack of claim 16, further comprising:
a platform coupled to and extending between at least one of the first peg housing and the second peg housing for receiving wheels of the motorcycle, and
a hitch mount coupled to at least one of the first peg housing and the second peg housing for mounting the rack to a hitch receiver of a motorized vehicle.

18. The rack of claim 17, further comprising:
a peg retainer mechanically coupled to the first peg housing configured to at least one of block the first peg housing such that the peg is trapped in the first peg housing and apply a forward force to the peg.

19. The rack of claim 18,
wherein the first peg housing and the second peg housing configured to adjust vertically relative to the platform to accommodate a height of the motorcycle,
wherein the first peg housing and the second peg housing configured to adjust horizontally to change the fixed distance to accommodate a width of the motorcycle, and
wherein the brace configured to adjust vertically to accommodate a height of a force point of the motorcycle for receiving the upward force of the brace.

20. The rack of claim 19, further comprising:
a first lock that locks the peg retainer in an engaged position to assist in securing the motorcycle, and
a second lock that locks the brace in an engaged position to assist in securing the motorcycle.

21. (canceled)

22. (canceled)

23. (canceled)

24. (canceled)
